(19) United States
(12) Patent Application Publication
(10) Pub. No.: US 2026/0229432 A1
(43) Pub. Date: Aug. 6, 2026

(54) ELECTRIC CIRCUIT BREAKER DEVICE

(71) Applicant: DAICEL CORPORATION, Osaka-shi, Osaka (JP)

(72) Inventors: Katsuhisa FUJITOU, Tokyo (JP); Katsuhiro NAKAHASHI, Tokyo (JP)

(73) Assignee: DAICEL CORPORATION, Osaka-shi, Osaka (JP)

(21) Appl. No.: 19/157,418

(22) PCT Filed: Nov. 24, 2023
(86) PCT No.: PCT/JP2023/042152

§ 371 Date: Aug. 18, 2025

(30) Foreign Application Priority Data
Feb. 21, 2023 (JP) 2023-025627

(51) Int. Cl. H01H 39/00; H01H 9/30; H01H 9/52

(52) U.S. Cl. CPC H01H 39/006; H01H 9/30; H01H 9/52

(57) ABSTRACT

Provided is an electric circuit breaker device including: a housing including an accommodating space inside, the accommodating space extending in one direction and including a projectile accommodating portion formed at one end side and an arc-extinguishing region portion formed at the other end side; an igniter provided at the housing; a projectile accommodated in the projectile accommodating portion and configured to be projected from the projectile accommodating portion toward the arc-extinguishing region portion side along the accommodating space by energy received from the igniter; and a conductor piece provided at the housing and forming a portion of an electric circuit, the conductor piece including, at a portion of the conductor piece, a cutoff portion to be cut off by the projectile, the cutoff portion being disposed crossing between the projectile accommodating portion and the arc-extinguishing region portion. The projectile includes, on a tip end side, a cutoff surface.

### TECHNICAL FIELD

The present invention relates to an electric circuit breaker device.

### BACKGROUND ART

An electric circuit may be provided with a breaker device that is actuated when an abnormality occurs in a device constituting the electric circuit or when an abnormality occurs in a system on which the electric circuit is mounted, thereby urgently interrupting the conduction of electricity in the electric circuit. As one aspect thereof, there has been proposed an electric circuit breaker device that forcibly and physically cuts a conductor piece forming a portion of an electric circuit by moving a projectile at high speed by energy applied from an igniter or the like. Further, in recent years, electric circuit breaker devices applied to electric vehicles equipped with a high-voltage power source have become increasingly important.

### CITATION LIST

### Patent Document

Patent Document 1: JP 2022-091560 A

Patent Document 2: US 2017/0,229,268 A

Patent Document 3: DE 102018133636 A

### SUMMARY OF INVENTION

### Technical Problem

In an electric circuit breaker device, after the conductor piece (bus bar) is cut by a projectile fired at the time of operation, the conductor piece may not be pushed deep. In this case, electrical insulation performance may be affected by conduction of the cut conductor piece. Therefore, it is desirable that the conductor piece after cutting is pushed deeper.

The technology of the present disclosure has been made in view of the above circumstances, and an object thereof is to provide an electric circuit breaker device in which a conductor piece after cutting is separated further.

### Solution to Problem

To solve the above problem, an electric circuit breaker device according to the present disclosure includes: a housing including an accommodating space inside, the accommodating space extending in one direction and including a projectile accommodating portion formed at one end side and an arc-extinguishing region portion formed at the other end side; an igniter provided at the housing; a projectile accommodated in the projectile accommodating portion and configured to be projected from the projectile accommodating portion toward the arc-extinguishing region portion side along the accommodating space by energy received from the igniter; and a conductor piece provided at the housing and forming a portion of an electric circuit, the conductor piece including, at a portion of the conductor piece, a cutoff portion to be cut off by the projectile, the cutoff portion being disposed crossing between the projectile accommodating portion and the arc-extinguishing region portion. The projectile includes, on a tip end side, a cutoff surface configured to cut off the cutoff portion at a time of actuation of the igniter, and at least one magnet is disposed at the arc-extinguishing region portion of the accommodating space.

### Advantageous Effects of Invention

According to the present disclosure, an electric circuit breaker device in which a conductor piece after cutting is separated further can be provided.

### BRIEF DESCRIPTION OF DRAWINGS

FIG. 1 is a view illustrating an internal structure of an electric circuit breaker device (hereinafter, simply referred to as a “breaker device”) 1 according to an embodiment.

FIG. 2 is a top view of a conductor piece according to the embodiment.

FIG. 3 is a view illustrating actuation situations of the breaker device 1 according to the embodiment.

FIG. 4 is a view illustrating an internal structure of a breaker device 1A according to Modification 1.

FIG. 5 is a view illustrating an internal structure of a breaker device 1B according to Modification 2.

FIG. 6 is a view illustrating an internal structure of a breaker device 1C according to Modification 3.

FIG. 7 is a top view of a conductor piece according to Modification 3.

### DESCRIPTION OF EMBODIMENTS

### First Embodiment

An electric circuit breaker device according to an embodiment of the present disclosure will be described below with reference to the drawings. Note that each of configurations, combinations thereof, and the like in the embodiments are an example, and various additions, omissions, substitutions, and other changes of the configurations may be made as appropriate without departing from the spirit of the present disclosure. The present disclosure is not limited by the embodiments and is limited only by the claims.

### Configuration

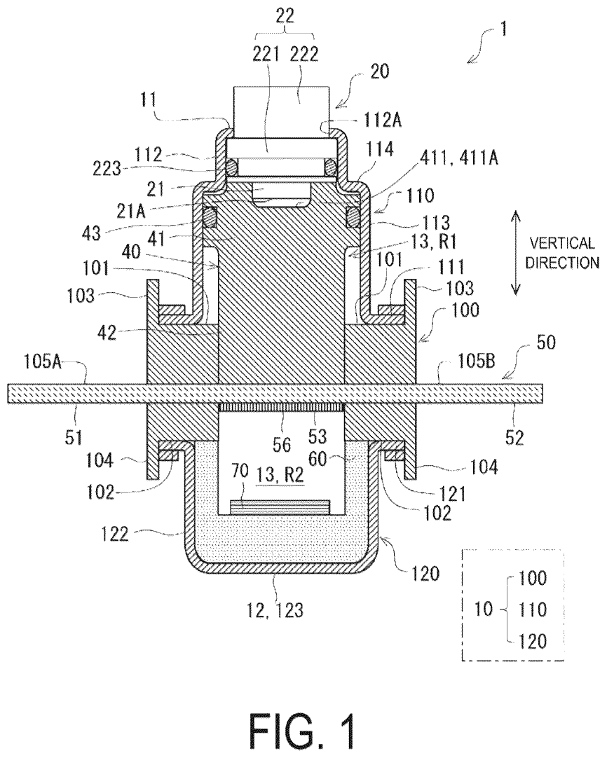

FIG. 1 is a view illustrating an internal structure of an electric circuit breaker device (hereinafter, simply referred to as a “breaker device”) 1 according to an embodiment. The breaker device 1 is a device that interrupts an electric circuit when an abnormality occurs in the electric circuit included in a vehicle, an electric home appliance, a photovoltaic system, or the like or in a system including a battery (lithium ion battery, for example) of the electric circuit, thereby preventing great damage. In the present specification, a cross section along a height direction in FIG. 1 (direction in which an accommodating space 13 described below extends) is referred to as a vertical cross section of the breaker device 1, and a cross section in a direction orthogonal to the height direction is referred to as a transverse cross section of the breaker device 1. FIG. 1 illustrates a state before actuation of the breaker device 1.

The breaker device 1 includes a housing 10 as an outer shell member, an igniter 20, a projectile 40, a conductor piece 50, and a coolant material 60. The housing 10 includes the accommodating space 13 that extends in a direction from a first end portion 11 on an upper end side to a second end portion 12 on a lower end side. This accommodating space 13 includes a space formed linearly, making the projectile 40 movable, and extends along a vertical direction of the breaker device 1. As illustrated in FIG. 1, the accommodating space 13 formed inside the housing 10 accommodates the projectile 40. However, in the present specification, the vertical direction of the breaker device 1 merely indicates a relative positional relationship among the elements in the breaker device 1 for convenience of description of the embodiment.

### Housing

The housing 10 includes a housing body 100, a top holder 110, and a bottom container 120. The housing body 100 is bonded to the top holder 110 and the bottom container 120, thereby forming the housing 10 that is integral.

The housing body 100 has, for example, a substantially rectangular columnar outer shape. However, the shape of the housing body 100 is not particularly limited. The housing body 100 includes a cavity portion formed therethrough along the vertical direction. This cavity portion forms a portion of the accommodating space 13. Furthermore, the housing body 100 includes an upper surface 101 to which a flange portion 111 of the top holder 110 is fixed and a lower surface 102 to which a flange portion 121 of the bottom container 120 is fixed. In the present embodiment, an upper tubular wall 103 having a tubular shape is provided erected upward from the upper surface 101 on an outer circumferential side of the upper surface 101 in the housing body 100. In the present embodiment, the upper tubular wall 103 has a rectangular tubular shape, for example, but may have other shapes. On an outer circumferential side of the lower surface 102 in the housing body 100, a lower tubular wall 104 having a tubular shape is provided suspended downward from the lower surface 102. In the present embodiment, the lower tubular wall 104 has a rectangular tubular shape, for example, but may have other shapes. The housing body 100 configured as described above can be formed from an insulating member such as a synthetic resin, for example. For example, the housing body 100 may be formed from nylon, which is a type of polyamide synthetic resin.

### Top Holder

Next, the top holder 110 will be described. The top holder 110 is, for example, a cylindrical member having a stepped circular tubular shape with a cavity inside. The top holder 110 includes a small diameter cylinder portion 112 positioned on the upper side (first end portion 11 side), a large diameter cylinder portion 113 positioned on the lower side, a connection portion 114 connecting these, and the flange portion 111 extending outward from a lower end of the large diameter cylinder portion 113. For example, the small diameter cylinder portion 112 and the large diameter cylinder portion 113 are coaxially disposed, and the large diameter cylinder portion 113 has a diameter slightly larger than that of the small diameter cylinder portion 112.

The contour of the flange portion 111 in the top holder 110 has a substantially quadrangular shape that fits inside the upper tubular wall 103 in the housing body 100. For example, the flange portion 111 may be integrally fastened to the upper surface 101 in the housing body 100 using a screw or the like, or may be fixed thereto by a rivet or the like, in a state of being disposed inside the upper tubular wall 103. Further, the top holder 110 may be bonded to the housing body 100 in a state where a sealant is applied between the upper surface 101 of the housing body 100 and a lower surface of the flange portion 111 in the top holder 110. This can increase airtightness of the accommodating space 13 formed in the housing 10. Further, instead of the sealant or in combination with the sealant, an O-ring or a gasket may be interposed between the upper surface 101 of the housing body 100 and the flange portion 111 of the top holder 110 to increase the airtightness of the accommodating space 13.

The cavity portion formed inside the small diameter cylinder portion 112 in the top holder 110 functions as an accommodating space for accommodating a portion of the igniter 20 as illustrated in FIG. 1. Further, the cavity portion formed inside the large diameter cylinder portion 113 in the top holder 110 communicates with the cavity portion of the housing body 100 positioned below, and forms a portion of the accommodating space 13. The top holder 110 configured as described above can be formed from an appropriate metal member, such as stainless steel or aluminum, having excellent strength and durability, for example. However, a material for forming the top holder 110 is not particularly limited. Also, for the shape of the top holder 110, the above aspect is an example and other shapes may be adopted.

### Bottom Container

Next, the bottom container 120 will be described. The bottom container 120 has a substantially tubular bottomed shape with a cavity inside, and includes a side wall portion 122, a bottom wall portion 123 connected to a lower end of the side wall portion 122, and a flange portion 121 connected to an upper end of the side wall portion 122. The side wall portion 122 has, for example, a circular tubular shape. The flange portion 121 extends outward from the upper end of the side wall portion 122. The contour of the flange portion 121 in the bottom container 120 has a substantially quadrangular shape that fits inside the lower tubular wall 104 in the housing body 100. For example, the flange portion 121 may be integrally fastened to the lower surface 102 in the housing body 100 using a screw or the like, or may be fixed thereto by a rivet or the like, in a state of being disposed inside the lower tubular wall 104. Here, the bottom container 120 may be bonded to the housing body 100 in a state where the sealant is applied between the lower surface 102 of the housing body 100 and an upper surface of the flange portion 121 in the bottom container 120. This can increase airtightness of the accommodating space 13 formed in the housing 10. Further, instead of the sealant or in combination with the sealant, an O-ring or a gasket may be interposed between the lower surface 102 of the housing body 100 and the flange portion 121 of the bottom container 120 to increase the airtightness of the accommodating space 13.

Note that the above aspect regarding the shape of the bottom container 120 is an example, and other shapes may be adopted. Further, the cavity portion formed inside the bottom container 120 communicates with the housing body 100 positioned above, and forms a portion of the accommodating space 13. The bottom container 120 configured as described above can be formed from an appropriate metal member, such as stainless steel or aluminum, having excellent strength and durability, for example. However, a material for forming the bottom container 120 is not particularly limited. Further, the bottom container 120 may have a multilayer structure. For example, in the bottom container 120, an exterior portion facing the outside may be formed using an appropriate metal member, such as stainless steel or aluminum, having excellent strength and durability, and an interior portion facing the accommodating space 13 may be formed using an insulating member such as a synthetic resin. Of course, the entire bottom container 120 may be formed using an insulating member. Further, the outer surface of the bottom container 120 may be covered with a member made of resin or the like.

As described above, the housing 10 in the embodiment includes the housing body 100, the top holder 110, and the bottom container 120 that are integrally assembled, and the accommodating space 13 extending in the direction from the first end portion 11 to the second end portion 12 is formed inside the housing 10. The accommodating space 13 accommodates the igniter 20, the projectile 40, a cutoff portion 53 of the conductor piece 50, the coolant material 60, and the like described in detail below.

### Igniter

Next, the igniter 20 will be described. The igniter 20 is an electric igniter that includes an ignition portion 21 with an ignition charge, and an igniter body 22 including a pair of electro-conductive pins (not illustrated) connected to the ignition portion 21. The igniter body 22 is surrounded by an insulating resin, for example. Further, tip end sides of the pair of electro-conductive pins in the igniter body 22 are exposed to the outside, and are connected to a power source when the breaker device 1 is used.

The igniter body 22 includes a body portion 221 having a substantially circular columnar shape and accommodated inside the small diameter cylinder portion 112 in the top holder 110, and a connector portion 222 positioned on the body portion 221. The igniter body 22 is fixed to the small diameter cylinder portion 112 by pressing, for example, the body portion 221 into an inner circumferential surface of the small diameter cylinder portion 112. Further, a constricted portion having an outer circumferential surface recessed as compared with other locations is annularly formed along a circumferential direction of the body portion 221 at an axially intermediate portion of the body portion 221. An O-ring 223 is fitted into this constricted portion. The O-ring 223 is formed from, for example, rubber (silicone rubber, for example) or a synthetic resin, and functions to increase airtightness between the inner circumferential surface in the small diameter cylinder portion 112 and the body portion 221.

The connector portion 222 in the igniter 20 is disposed protruding to the outside through an opening 112A formed at an upper end of the small diameter cylinder portion 112. The connector portion 222 has, for example, a circular tubular shape covering sides of the electro-conductive pins, allowing connection with a connector of a power source.

As illustrated in FIG. 1, the ignition portion 21 of the igniter 20 is disposed facing the accommodating space 13 (more specifically, the cavity portion formed inside the large diameter cylinder portion 113) of the housing 10. The ignition portion 21 is configured as a form accommodating an ignition charge in an igniter cup, for example. For example, the ignition charge is accommodated in the igniter cup in the ignition portion 21 in a state of being in contact with a bridge wire (resistor) suspended coupling the base ends of the pair of electro-conductive pins to each other. As the ignition charge, for example, zirconium-potassium perchlorate (ZPP), zirconium-tungsten-potassium perchlorate (ZWPP), titanium hydride-potassium perchlorate (THPP), lead tricinate, or the like may be adopted.

In actuation of the igniter 20, when an actuating current for igniting the ignition charge is supplied from the power source to the electro-conductive pins, the bridge wire in the ignition portion 21 generates heat, and as a result, the ignition charge in the igniter cup is ignited and burns, generating a combustion gas. Then, the pressure in the igniter cup increases along with the combustion of the ignition charge in the igniter cup of the ignition portion 21, a rupture surface 21A of the igniter cup ruptures, and the combustion gas is discharged from the igniter cup into the accommodating space 13. More specifically, the combustion gas from the igniter cup is discharged into a depressed portion 411 in a piston portion 41 described below of the projectile 40 disposed in the accommodating space 13.

### Projectile

Next, the projectile 40 will be described. The projectile 40 is formed from an insulating member such as a synthetic resin, for example, and includes the piston portion 41 and a rod portion 42 connected to the piston portion 41. The piston portion 41 has a substantially circular columnar shape and has an outer diameter substantially corresponding to an inner diameter of the large diameter cylinder portion 113 in the top holder 110. For example, the diameter of the piston portion 41 may be slightly smaller than the inner diameter of the large diameter cylinder portion 113. The shape of the projectile 40 can be changed as appropriate according to the shape of the housing 10 and the like.

Further, the depressed portion 411 having a circular columnar shape, for example, is formed in an upper surface of the piston portion 41. This depressed portion 411 receives the ignition portion 21. A bottom surface of the depressed portion 411 is formed as a pressure receiving surface 411A that receives energy received from the igniter 20 at a time of actuation of the igniter 20. Further, a constricted portion having an outer circumferential surface recessed as compared with other locations is annularly formed along a circumferential direction of the piston portion 41 at an axially intermediate portion of the piston portion 41. An O-ring 43 is fitted into this constricted portion. The O-ring 43 is formed from, for example, rubber (silicone rubber, for example) or a synthetic resin, and functions to increase airtightness between an inner circumferential surface in the large diameter cylinder portion 113 and the piston portion 41.

The rod portion 42 of the projectile 40 is a rod-shaped member having an outer circumferential surface smaller in diameter than the piston portion 41, for example, and is integrally connected to a lower end side of the piston portion 41. A lower end surface of the rod portion 42 is formed as a cutoff surface 421 for cutting off the cutoff portion 53 from the conductor piece 50 at a time of actuation of the breaker device 1. Note that although the rod portion 42 in the present embodiment has a substantially circular columnar shape, the shape thereof is not particularly limited, and can be changed in accordance with the shape and size of the cutoff portion 53 to be cut off from the conductor piece 50 at a time of actuation of the breaker device 1. The rod portion 42 may have a columnar shape such as a circular tubular shape or a rectangular column, for example. Note that, in an initial position of the projectile 40 illustrated in FIG. 1, a region on a tip end side including the cutoff surface 421 in the rod portion 42 of the projectile 40 is positioned in the cavity portion (forming a portion of the accommodating space 13) of the housing body 100. The diameter of the rod portion 42 is slightly smaller than the inner diameter of an inner circumferential surface of the housing body 100, for example, and the outer circumferential surface of the rod portion 42 is guided along the inner circumferential surface when the projectile 40 is projected.

As described in detail below, in the projectile 40 configured as described above, the projectile 40 is projected from the initial position illustrated in FIG. 1 when the upper surface of the piston portion 41 including the pressure receiving surface 411A receives the energy from the igniter 20 at a time of actuation of the igniter 20, and moves at high speed toward the second end portion 12 side (downward) along the accommodating space 13. Specifically, as illustrated in FIG. 1, the piston portion 41 of the projectile 40 is accommodated inside the large diameter cylinder portion 113 in the top holder 110, and is slidable in the axis direction along an inner wall surface of the large diameter cylinder portion 113. In the present embodiment, the piston portion 41 of the projectile 40 has a substantially circular columnar shape, but the shape thereof is not particularly limited. As the outer shape of the piston portion 41, an appropriate shape and size can be adopted in accordance with the shape and size of the inner wall surface of the large diameter cylinder portion 113.

### Conductor Piece

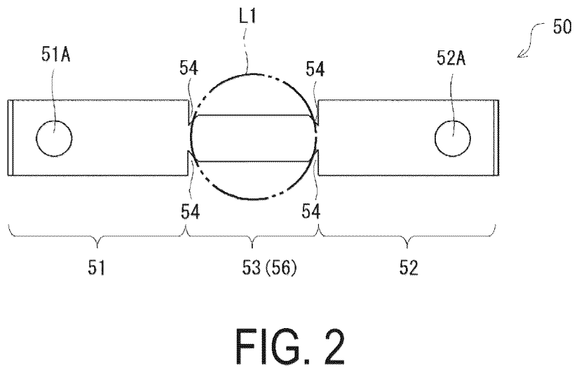

Next, the conductor piece 50 will be described. FIG. 2 is a top view of the conductor piece 50 according to the embodiment. The conductor piece 50 is a conductor that constitutes a part of the components of the breaker device 1 and, when the breaker device 1 is attached to a predetermined electric circuit, forms a part of the electric circuit, and may be referred to as a bus bar. The conductor piece 50 can be formed from a metal such as copper (Cu), for example. However, the conductor piece 50 may be formed using a metal other than copper, or may be formed using an alloy of copper and another metal. Note that examples of metals other than copper included in the conductor piece 50 include manganese (Mn), nickel (Ni), platinum (Pt), aluminum (Al), brass, gold (Au), silver (Ag), and duralumin.

In one aspect illustrated in FIG. 2, the conductor piece 50 is formed as an elongated flat plate piece as a whole, and includes a first connection end portion 51 and a second connection end portion 52 on both end sides, and the cutoff portion 53 positioned in an intermediate portion therebetween. Connection holes 51A and 52A are provided in the first connection end portion 51 and the second connection end portion 52 of the conductor piece 50, respectively. These connection holes 51A and 52A are used to connect with other conductors (lead wires, for example) in the electric circuit. Note that in FIG. 1, the connection holes 51A and 52A in the conductor piece 50 are not illustrated. The cutoff portion 53 of the conductor piece 50 is a portion forcibly and physically cut by the rod portion 42 of the projectile 40 and is cut off from the first connection end portion 51 and the second connection end portion 52 when an abnormality such as excessive current occurs in the electric circuit to which the breaker device 1 is applied. Notches (slits) 54 are formed at both ends of the cutoff portion 53 of the conductor piece 50, making it easy to cut and cut off the cutoff portion 53.

Here, various forms of the conductor piece 50 can be adopted, and a shape thereof is not particularly limited. While, in the example illustrated in FIG. 2, surfaces of the first connection end portion 51, the second connection end portion 52, and the cutoff portion 53 form the same surface, the form is not limited thereto. For example, the conductor piece 50 may be connected such that the cutoff portion 53 is orthogonal to or inclined relative to the first connection end portion 51 and the second connection end portion 52. Further, the planar shape of the cutoff portion 53 of the conductor piece 50 is not particularly limited, either. Of course, the shapes of the first connection end portion 51 and the second connection end portion 52 of the conductor piece 50 are not particularly limited, either. Further, the notches 54 in the conductor piece 50 can be omitted as appropriate.

Here, a pair of conductor piece holding holes 105A and 105B are formed in the housing body 100 according to the embodiment. The pair of conductor piece holding holes 105A and 105B extend in a transverse cross-sectional direction orthogonal to the vertical direction (axis direction) of the housing body 100. More specifically, the pair of conductor piece holding holes 105A and 105B extend in a straight line with the cavity portion (accommodating space 13) of the housing body 100 interposed therebetween. The conductor piece 50 configured as described above is held in the housing body 100 in a state of being inserted through the pair of conductor piece holding holes 105A and 105B formed in the housing body 100. In the example illustrated in FIG. 1. the first connection end portion 51 of the conductor piece 50 is held in a state of being inserted through the conductor piece holding hole 105A, and the second connection end portion 52 is held in a state of being inserted through the conductor piece holding hole 105B. In this state, the cutoff portion 53 of the conductor piece 50 is positioned in the cavity portion (accommodating space 13) of the housing body 100. As described above, the conductor piece 50 attached to the housing body 100 is held orthogonally to the extending direction (axis direction) of the accommodating space 13 with the cutoff portion 53 crossing the accommodating space 13. Note that reference sign L1 illustrated in FIG. 2 denotes an outer circumferential position of the rod portion 42 positioned above the conductor piece 50 in a state where the conductor piece 50 is attached to the housing body 100 of the breaker device 1. In the present embodiment, the conductor piece 50 is installed with the outer circumferential position L1 of the rod portion 42 substantially overlapping the positions of the notches 54 positioned at both ends of the cutoff portion 53. In the present embodiment, for example, since a transverse cross-sectional area of the accommodating space 13 is larger than a transverse cross-sectional area of the cutoff portion 53, a gap is formed on the side of the cutoff portion 53.

The ferromagnetic body 56 is attached to the bottom container 120 side of the cutoff portion 53. The ferromagnetic body 56 is a metal having ferromagnetism. The ferromagnetic body 56 has, for example, the same shape as that of the cutoff portion 53, and is fixed to the cutoff portion 53 by being attached thereto with an adhesive or the like. Alternatively, the bottom container 120 side of the cutoff portion 53 may be subjected to plating treatment in which plating containing a metal having ferromagnetism is applied. Alternatively, the conductor piece 50 itself may be made of a metal having ferromagnetism. Here, the metal having ferromagnetism is, for example, iron, cobalt, nickel, gadolinium, ruthenium, an alloy containing them, ferrite, or the like. Further, the ferromagnetic body 56 may be attached to the top holder 110 side of the cutoff portion 53, or the top holder 110 side of the cutoff portion 53 may be subjected to plating treatment in which plating containing a metal having ferromagnetism is applied. Further, a magnet may be attached to the cutoff portion 53. The magnet can be made of a material similar to that of a magnet 70 described below.

### Coolant Material

Next, the coolant material 60 disposed in the accommodating space 13 in the housing 10 will be described. Here, as illustrated in FIG. 1, prior to actuation of the breaker device 1 (igniter 20), the cutoff portion 53 of the conductor piece 50 in a state of being held in the pair of conductor piece holding holes 105A and 105B in the housing body 100 is horizontally laid crossing the accommodating space 13 of the housing 10. Hereinafter, of regions vertically positioned with reference to the cutoff portion 53 of the conductor piece 50 in the accommodating space 13 of the housing 10, a region (space) in which the projectile 40 is disposed is referred to as a “projectile initial arrangement region R1”, and a region (space) positioned on the opposite side of the projectile 40 is referred to as an “arc-extinguishing region R2”. Note that as described above, since the gap is formed on the side of the cutoff portion 53 disposed across the accommodating space 13, the projectile initial arrangement region R1 and the arc-extinguishing region R2 are not completely isolated from each other by the cutoff portion 53, but communicate with each other. Of course, depending on the shape and size of the cutoff portion 53, the projectile initial arrangement region R1 and the arc-extinguishing region R2 may be completely isolated from each other by the cutoff portion 53. The projectile initial arrangement region R1 is an example of a projectile accommodating portion, The arc-extinguishing region R2 is an example of an arc-extinguishing region portion. In the accommodating space 13, the projectile initial arrangement region R1 and the arc-extinguishing region R2 extend in one direction.

The arc-extinguishing region R2 of the accommodating space 13 is a region (space) for receiving the cutoff portion 53 cut off by the rod portion 42 of the projectile 40 projected at a time of actuation of the breaker device 1 (igniter 20). In this arc-extinguishing region R2, the coolant material 60 as an arc-extinguishing material is disposed. The coolant material 60 is a coolant material for removing thermal energy of the cutoff portion 53 and the arc generated when the projectile 40 cuts off the cutoff portion 53 of the conductor piece 50, and cooling the arc and the cutoff portion 53, thereby suppressing arc generation during interruption of a current or thereby extinguishing (eliminating) the generated arc.

The arc-extinguishing region R2 of the breaker device 1 has significance as a space for receiving the cutoff portion 53 cut off from the first connection end portion 51 and the second connection end portion 52 of the conductor piece 50 by the projectile 40 and, at the same time, as a space for effectively extinguishing the arc generated when the projectile 40 cuts off the cutoff portion 53. Then, the coolant material 60 is disposed as an arc-extinguishing material in the arc-extinguishing region R2, thereby effectively extinguishing the arc generated when the cutoff portion 53 is cut off from the conductor piece 50.

As one aspect of the embodiment, the coolant material 60 is solid. As one aspect of the embodiment, the coolant material 60 is formed from a shape retaining body. The shape retaining body herein is, for example, a material that can keep a constant shape when no external force is applied and can hold the integrity (does not come apart), even if deformation can occur, when an external force is applied. For example, examples of the shape retaining body include a fibrous body formed into a desired shape. In the present embodiment, the coolant material 60 is formed from a metal fiber that is a shape retaining body. Here, examples of the metal fiber forming the coolant material 60 include an aspect in which at least any one of steel wool or copper wool is included. The coolant material 60 may include an inorganic oxide such as zeolite, silica, or alumina. However, the above aspects in the coolant material 60 are examples, and the coolant material 60 is not limited to the above aspects.

The coolant material 60 is formed into, for example, a bowl-like shape, and is disposed along an inner wall and a bottom portion of the bottom container 120 (the arc-extinguishing region R2 of the accommodating space 13). Further, the coolant material 60 may be formed into a disk-like shape, and disposed along the bottom portion of the bottom container 120.

Further, the coolant material 60 may be a modified resin material functioning as an arc-extinguishing material. When the igniter 20 is actuated, the modified resin material is modified by heat of the cutoff portion 53 and the arc generated by the projectile 40 cutting off the cutoff portion 53 of the conductor piece 50, and this modification consumes thermal energy, thereby contributing to extinguishing (eliminating) of the arc. Note that the modified resin material is modified mainly by heat of the arc, but in addition to this, the modified resin material is affected by heat such as the heat generated when the cutoff portion 53 is cut off and combustion heat of the ignition charge, and the heat received from ignition of the ignition charge to extinguishing completion is called heat associated with actuation of the igniter 20.

The modified resin material is a synthetic resin including silicone. Note that the modified resin material is not limited to silicone, and may be a material using another resin such as polyurethane, polyethylene, polypropylene, polyamide, or nitrile rubber. The modified resin material may be any material as long as at least a part thereof is modified by heat, and may be made of a composite material including glass, ceramic fillers, or the like. The modified resin material is made of a material that is easily modified such as being decomposed or being volatilized by heat as compared with other resin materials from which the housing 10 and the projectile 40 are made, and the heat of the arc can be effectively consumed by this modification. In the modified resin material of the present embodiment, a component such as silica generated by thermal decomposition exhibits a high resistance value, and scattering of the components can contribute to improvement of insulation after cutting.

The modified resin material is not limited to a solid member formed in a predetermined shape, and may be a gel-like material or a highly viscous liquid material which is used by being applied to a wall surface in the accommodating space 13. The modified resin material may be fixedly provided on the wall surface in the accommodating space 13 by applying a synthetic resin melted with an organic solvent such as toluene to the wall surface and then volatilizing the organic solvent.

### Magnet

Next, the magnet 70 disposed in the accommodating space 13 in the housing 10 will be described. The magnet 70 is disposed to sandwich the coolant material 60 disposed at the bottom portion of the bottom container 120 (the arc-extinguishing region R2 of the accommodating space 13) between the magnet 70 and the bottom portion of the bottom container 120. The magnet 70 attracts the cutoff portion 53 of the conductor piece 50 which has been cut off when the igniter 20 is actuated. The cutoff portion 53 is attracted to the magnet 70 by the ferromagnetic body 56 or the like attached to the cutoff portion 53. The magnet 70 is, for example, an alloy magnet such as an alnico magnet or an iron-chromium-cobalt magnet. The magnet 70 is, for example, a rare earth magnet such as a neodymium magnet or a samarium-cobalt magnet. Further, the magnet 70 may be subjected to a known surface treatment to improve wear resistance, corrosion resistance, and insulation property.

### Operation

Next, details of operation when the breaker device 1 is actuated to interrupt the electric circuit will be described. As described above, FIG. 1 illustrates a state of the breaker device 1 prior to actuation (hereinafter also referred to as the “pre-actuation initial state”). In this pre-actuation initial state, the projectile 40 in the breaker device 1 is set at an initial position where the piston portion 41 is positioned on the first end portion 11 side (upper end side) in the accommodating space 13, and the cutoff surface 421 formed at the lower end of the rod portion 42 is positioned on the upper surface of the cutoff portion 53 in the conductor piece 50.

Furthermore, the breaker device 1 according to the embodiment further includes an abnormality detection sensor (not illustrated) that detects an abnormal state of a device (such as a vehicle, a power generation facility, or a power storage facility) to which an electric circuit to be interrupted is connected, and a control unit (not illustrated) that controls the actuation of the igniter 20. The abnormality detection sensor may be able to detect an abnormal state on the basis of a voltage or a temperature of the conductor piece 50 in addition to the current flowing through the conductor piece 50. Further, the abnormality detection sensor may be, for example, an impact sensor, a temperature sensor, an acceleration sensor, a vibration sensor, or the like, and may detect an abnormal state such as an accident or fire on the basis of an impact, a temperature, acceleration, or vibration in a device such as a vehicle. The control unit of the breaker device I is a computer that can perform a predetermined function by executing a predetermined control program, for example. The predetermined function of the control unit may be achieved by corresponding hardware. When an excessive current flows through the conductor piece 50 forming a portion of the electric circuit to which the breaker device 1 is applied, the abnormal current is detected by the abnormality detection sensor. Abnormality information regarding the detected abnormal current is passed from the abnormality detection sensor to the control unit. For example, the control unit is energized from an external power source (not illustrated) connected to the electro-conductive pins of the igniter 20 and actuates the igniter 20 on the basis of the current value detected by the abnormality detection sensor. Here, the abnormal current may be a current having a current value that exceeds a predetermined threshold value set for protection of a predetermined electric circuit. Note that the abnormality detection sensor and the control unit described above need not be included in the components of the breaker device 1, and may be included in a device separate from the breaker device 1, for example. Further, the abnormality detection sensor and the control unit are not essential configurations of the breaker device 1.

For example, when an abnormal current of the electric circuit is detected by an abnormality detection sensor that detects an abnormal current of the electric circuit, the control unit of the breaker device 1 actuates the igniter 20. That is, an actuating current is supplied from the external power source (not illustrated) to the electro-conductive pins of the igniter 20, and as a result, the ignition charge in the ignition portion 21 is ignited and burns, generating a combustion gas. Then, the rupture surface 21A ruptures due to rise in pressure in the ignition portion 21, and the combustion gas of the ignition charge is discharged from the inside of the ignition portion 21 into the accommodating space 13.

Here, the ignition portion 21 of the igniter 20 is received in the depressed portion 411 of the piston portion 41, and the rupture surface 21A of the ignition portion 21 is disposed facing the pressure receiving surface 411A of the depressed portion 411 in the projectile 40. Therefore, the combustion gas from the ignition portion 21 is discharged to the depressed portion 411, and the pressure (combustion energy) of the combustion gas is transmitted to the upper surface of the piston portion 41 including the pressure receiving surface 411A. As a result, the projectile 40 moves downward along the accommodating space 13 in the extending direction (axis direction) of the accommodating space 13.

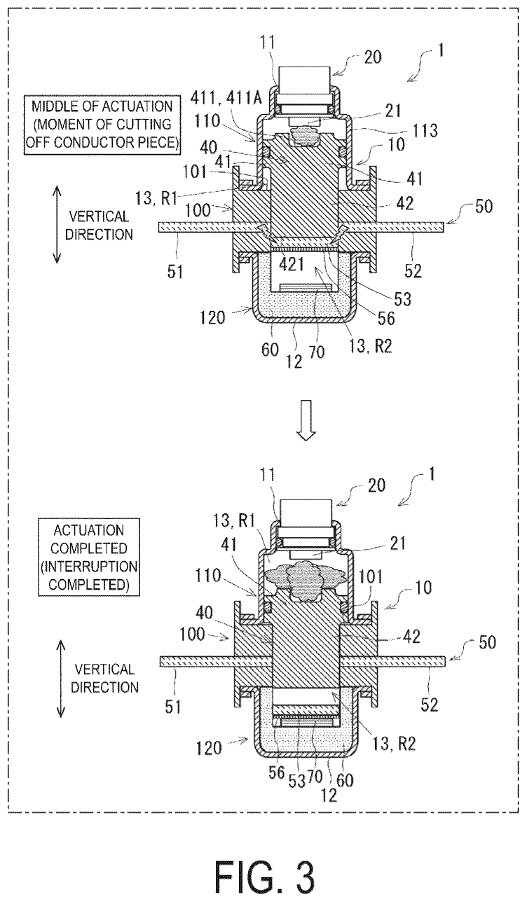

FIG. 3 is a view illustrating actuation situations of the breaker device 1 according to the embodiment. The upper half of FIG. 3 illustrates a situation in the middle of actuation of the breaker device 1, and the lower half of FIG. 3 illustrates a situation in which the actuation of the breaker device 1 is completed. As described above, upon actuation of the igniter 20, the projectile 40 having received the pressure (combustion energy) of the combustion gas of the ignition charge is vigorously pushed downward. As a result, the cutoff surface 421 formed on the lower end side of the rod portion 42 pressingly cuts, by shearing, the boundary portions between the first connection end portion 51 and the cutoff portion 53 and between the second connection end portion 52 and the cutoff portion 53 in the conductor piece 50. As a result, the cutoff portion 53 is cut off from the conductor piece 50. Note that as long as the projectile 40 can be moved smoothly in the extending direction (axis direction) of the accommodating space 13 when the igniter 20 is actuated, the shape and the dimensions of the projectile 40 can be freely determined, and the outer diameter of the piston portion 41 of the projectile 40 may be set to a dimension equal to the inner diameter of the large diameter cylinder portion 113 in the top holder 110, for example.

Then, as illustrated in the lower half of FIG. 3, the projectile 40 moves downward in the extending direction (axis direction) of the accommodating space 13 by a predetermined stroke until the lower end surface of the piston portion 41 abuts against (collides with) the upper surface 101 of the housing body 100. In this state, the cutoff portion 53 cut off from the conductor piece 50 by the rod portion 42 of the projectile 40 is received in the arc-extinguishing region R2 where the coolant material 60 is disposed. Further, the cutoff portion 53 is attracted to the magnet 70 together with the ferromagnetic body 56 and the like. As a result, the first connection end portion 51 and the second connection end portion 52 positioned on both ends of the conductor piece 50 are electrically disconnected, and the predetermined electric circuit to which the breaker device 1 is applied is forcibly interrupted.

In the breaker device 1 of the embodiment, the coolant material 60 is disposed in the arc-extinguishing region R2. Therefore, the cutoff portion 53 after being cut off that has been received in the arc-extinguishing region R2 can be rapidly cooled by the coolant material 60. Thus, when the cutoff portion 53 is cut off from the conductor piece 50 constituting a portion of the predetermined electric circuit by the projectile 40, even in a case where an arc is generated at the cut surface of the cutoff portion 53 of the conductor piece 50, the generated arc can be quickly and effectively extinguished. Further, by attracting the cutoff portion 53 to the bottom portion side of the bottom container 120 by the magnet 70, it is possible to increase the distance between the cutoff portion 53 and the first connection end portion 51 and the second connection end portion 52.

As described above, according to the breaker device 1 of the present embodiment, the cutoff portion 53 which has been cut can be attracted to the magnet 70. As a result, it is possible to quickly interrupt the electric circuit to which the breaker device 1 is applied in a case where an abnormality is detected in the electric circuit, or the like. That is, by separating the cutoff portion 53 from the first connection end portion 51 and the second connection end portion 52 more quickly and further, it is possible to suppress the delay of the interruption of the electric circuit.

### Modification 1

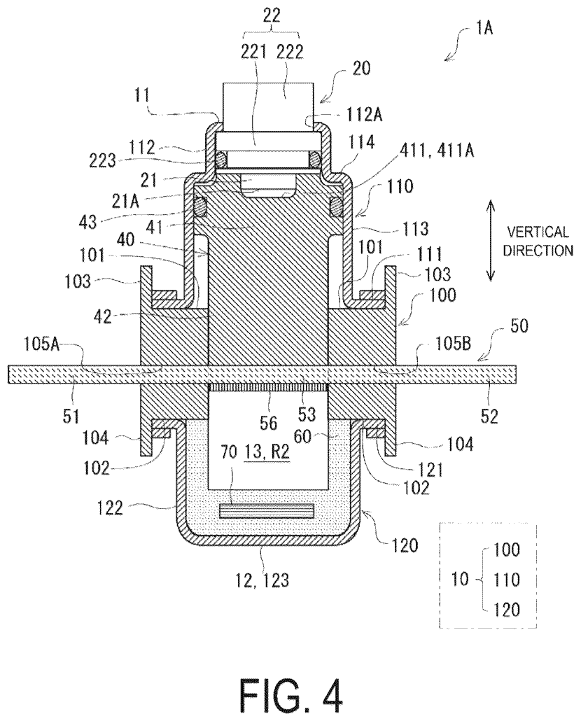

FIG. 4 is a view illustrating an internal structure of a breaker device 1A according to Modification 1. The configuration of the breaker device 1A of Modification 1 differs from that of the breaker device 1 illustrated in FIG. 1 in the position of the magnet 70. In the breaker device 1A of Modification 1, the magnet 70 is disposed inside the coolant material 60 disposed at the bottom portion of the bottom container 120. Since the magnet 70 is disposed inside the coolant material 60, the magnet 70 can be easily fixed. Further, since the magnet 70 is disposed inside the coolant material 60, the distance between the cutoff portion 53 attracted to the magnet 70 and the first connection end portion 51 and the second connection end portion 52 can be made longer than that of the breaker device 1 illustrated in FIG. 1, and the insulation property can be further enhanced.

### Modification 2

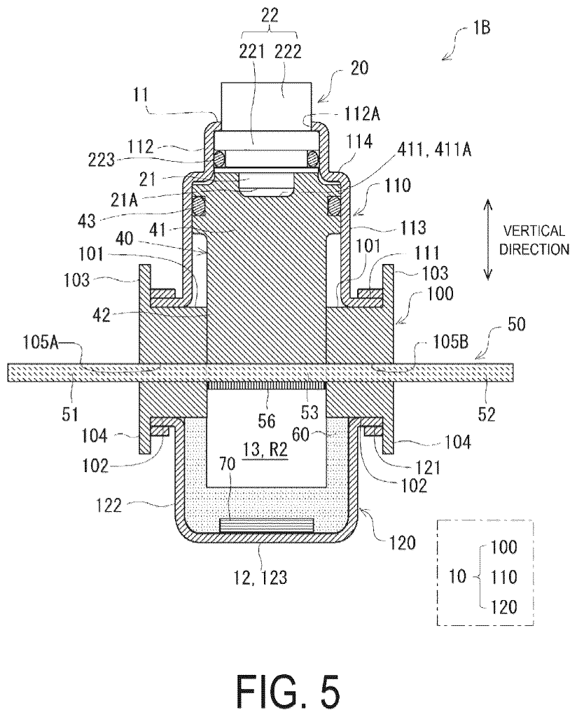

FIG. 5 is a view illustrating an internal structure of a breaker device 1B according to Modification 2. The configuration of the breaker device 1B of Modification 2 is different from those of the breaker device 1 illustrated in FIG. 1 and the breaker device 1A illustrated in FIG. 4 in the position of the magnet 70. In the breaker device 1B of Modification 2, the magnet 70 is disposed at the bottom portion of the bottom container 120. Since the magnet 70 is disposed at the bottom portion of the bottom container 120, the magnet 70 can be easily fixed. Further, since the magnet 70 is disposed on the bottom container 120, the distance between the cutoff portion 53 attracted to the magnet 70 and the first connection end portion 51 and the second connection end portion 52 can be made longer than that of the breaker device 1A illustrated in FIG. 4, and the insulation property can be further enhanced.

### Modification 3

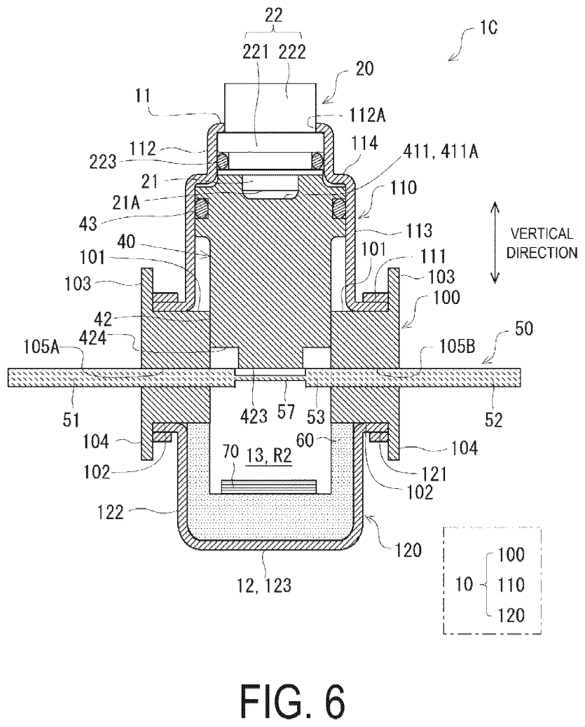

FIG. 6 is a view illustrating an internal structure of a breaker device 1C according to Modification 3. The configuration of the breaker device 1C of Modification 3 is different from that of the breaker device 1 illustrated in FIG. 1 in the rod portion 42 and the conductor piece 50. While the lower end surface of the rod portion 42 of the breaker device 1 of FIG. 1 is the cutoff surface 421. the lower end surface of the rod portion 42 of the breaker device IC of Modification 3 is formed as a two stage cutoff surface of a first cutoff surface 423 and a second cutoff surface 424. The first cutoff surface 423 has a diameter smaller than the diameter of the rod portion 42. The second cutoff surface 424 has the same diameter as the rod portion 42. A surface on the conductor piece 50 side of a portion protruding in a circular columnar shape from a central portion of the second cutoff surface 424 is the first cutoff surface 423. The cutoff portion 53 of the conductor piece 50 has a thin portion 57 at the center thereof. The thin portion 57 is thinner than other portions of the conductor piece 50 and is more likely to be cut. In FIG. 5, the ferromagnetic body 56 is omitted. Here, the ferromagnetic body 56 and the magnet 70 may not be present.

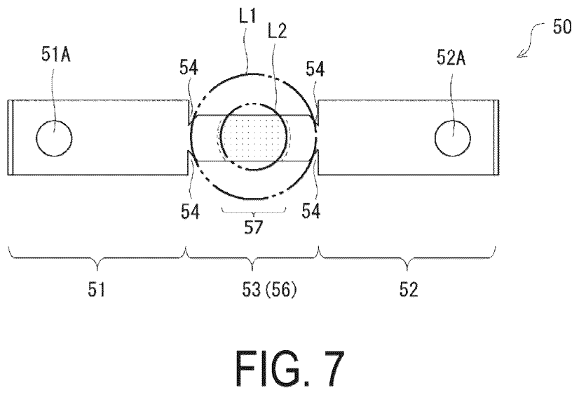

FIG. 7 is a top view of the conductor piece 50 according to Modification 3. The conductor piece 50 of Modification 3 is different from the conductor piece 50 illustrated in FIG. 2 in the configuration of the cutoff portion 53. The cutoff portion 53 of Modification 3 has the thin portion 57 at the center. Reference sign L1 illustrated in FIG. 7 denotes an outer circumferential position of the second cutoff surface 424 positioned above the conductor piece 50 in a state where the conductor piece 50 is attached to the housing body 100 of the breaker device 1C. Reference sign L2 illustrated in FIG. 7 denotes an outer circumferential position of the first cutoff surface 423 positioned above the conductor piece 50 in a state where the conductor piece 50 is attached to the housing body 100 of the breaker device IC. In the present embodiment, the conductor piece 50 is installed with the outer circumferential position L1 of the second cutoff surface 424 substantially overlapping the positions of the notches 54 positioned at both ends of the cutoff portion 53, and installed with the outer circumferential position L2 of the first cutoff surface 423 crossing the thin portion 57 of the cutoff portion 53.

Upon actuation of the igniter 20, the projectile 40 having received the pressure (combustion energy) of the combustion gas of the ignition charge is vigorously pushed downward. As a result, the first cutoff surface 423 formed on the lower end side of the rod portion 42 pressingly cuts, by shearing, the thin portion 57 of the cutoff portion 53 in the conductor piece 50. Further, the second cutoff surface 424 of the rod portion 42 pressingly cuts, by shearing, each of the boundary portions between the first connection end portion 51 and the cutoff portion 53 and between the second connection end portion 52 and the cutoff portion 53. As a result, the thin portion 57 is cut off from the cutoff portion 53, and the remaining portions of the cutoff portion 53 (the portions other than the portion cut off by the first cutoff surface 423) are cut off from the first connection end portion 51 and the second connection end portion 52. As a result, when the cutoff portion 53 is cut off from the conductor piece 50, the cutoff portion 53 is cut into a plurality of portions, and a predetermined electric circuit to which the breaker device 1 is applied is forcibly interrupted. By cutting the cutoff portion 53 into a plurality of portions, the insulation property can be further enhanced.

While the embodiment of the electric circuit breaker device according to the present disclosure has been described above, each of the aspects disclosed in the present specification can be combined with any other feature disclosed in the present specification.

### REFERENCE SIGNS LIST

1 Breaker device
10 Housing
13 Accommodating space
20 Igniter
40 Projectile
50 Conductor piece
53 Cutoff portion
56 Ferromagnetic body
60 Coolant material
70 Magnet

1. An electric circuit breaker device comprising:
a housing including an accommodating space inside, the accommodating space extending in one direction and including a projectile accommodating portion formed at one end side and an arc-extinguishing region portion formed at the other end side;
an igniter provided at the housing;
a projectile accommodated in the projectile accommodating portion and configured to be projected from the projectile accommodating portion toward the arc-extinguishing region portion side along the accommodating space by energy received from the igniter; and
a conductor piece provided at the housing and forming a portion of an electric circuit, the conductor piece including, at a portion of the conductor piece, a cutoff portion to be cut off by the projectile, the cutoff portion being disposed crossing between the projectile accommodating portion and the arc-extinguishing region portion, wherein
the projectile includes, on a tip end side, a cutoff surface configured to cut off the cutoff portion at a time of actuation of the igniter, and
at least one magnet is disposed at the arc-extinguishing region portion of the accommodating space.

2. The electric circuit breaker device according to claim 1, wherein
a metal having ferromagnetism is fixed to the cutoff portion of the conductor piece.

3. The electric circuit breaker device according to claim 1, wherein
a magnet is attached to the cutoff portion of the conductor piece.

4. The electric circuit breaker device according to claim 1, wherein
the conductor piece is an alloy containing a metal having ferromagnetism.

5. The electric circuit breaker device according to claim 1, wherein
the cutoff portion of the conductor piece is subjected to plating treatment in which plating containing a metal having ferromagnetism is applied.

6. The electric circuit breaker device according to claim 1, comprising
a coolant material disposed along a bottom portion of the arc-extinguishing region portion of the accommodating space, wherein
the magnet is disposed at a position where the coolant material is interposed between the magnet and the bottom portion.

7. The electric circuit breaker device according to claim 1, comprising
a coolant material disposed along a bottom portion of the arc-extinguishing region portion of the accommodating space, wherein
the magnet is disposed inside the coolant material.

8. The electric circuit breaker device according to claim 1, wherein
the magnet is disposed at a bottom portion of the arc-extinguishing region portion of the accommodating space.

9. The electric circuit breaker device according to claim 1, wherein
the magnet is a neodymium magnet.
